(19) United States
(12) Patent Application Publication
(10) Pub. No.: US 2014/0111322 A1
(43) Pub. Date: Apr. 24, 2014

(54) System and Method for Capturing and Transmitting Real Time Sports Performance Data

(71) Applicant: Chad Steelberg, Newport, CA (US)

(72) Inventor: Chad Steelberg, Newport, CA (US)

(21) Appl. No.: 14/061,644

(22) Filed: Oct. 23, 2013

Related U.S. Application Data
(60) Provisional application No. 61/717,411, filed on Oct. 23, 2012.

(51) Int. Cl. A63B 71/06; G08C 17/02

(52) U.S. Cl. CPC A63B 71/06; G08C 17/02
USPC 340/323 R

(57) ABSTRACT

The present invention provides an engine, system and method for capturing and transmitting real time sports performance data to a data base/smart phone using short distance wireless communication.

### FIELD OF THE INVENTION

The present invention relates to capturing and transmitting real time sports performance data to a data base/smart phone using short distance wireless communication.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIG. 3 illustrates and exemplary embodiment of the herein described systems and methods.

### DETAILED DESCRIPTION

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

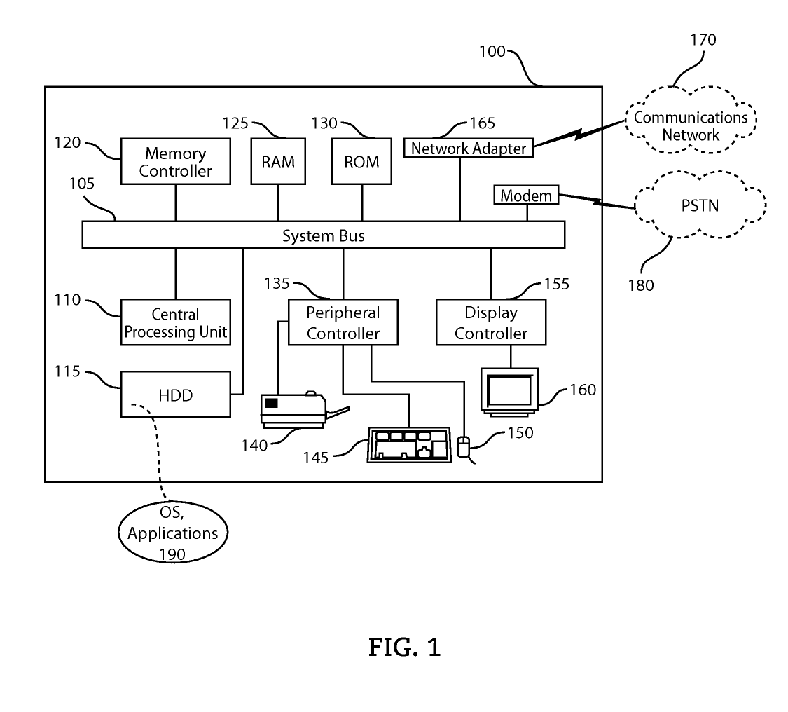

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

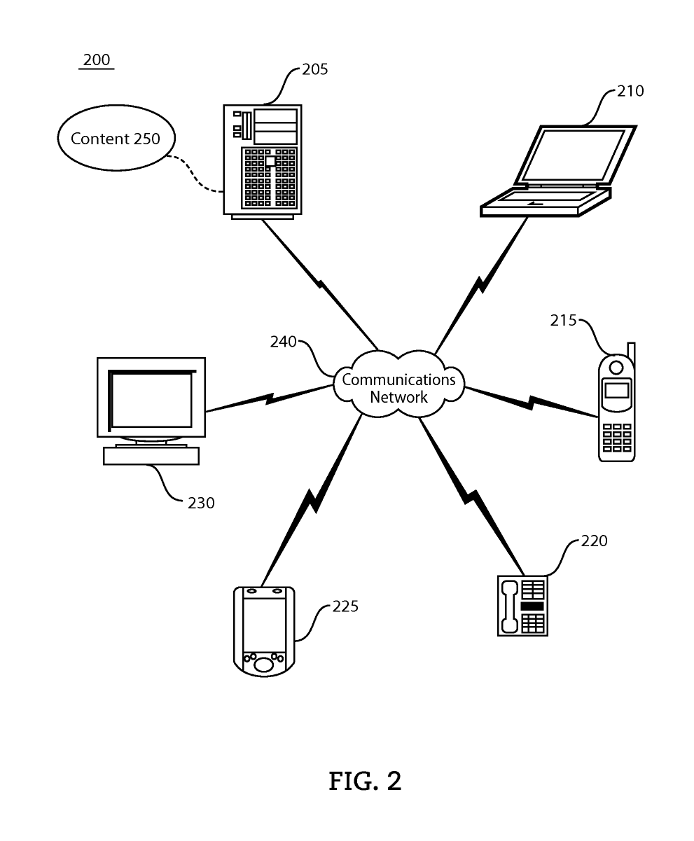

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (POP), virtual private network (VP N) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SC-FDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fl), IEEE 802.16 (WiMAX), IEEE 802.20, Flash-OFDM®, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3GPP2).

“WiFi” stands for “Wireless Fidelity.” WiFi is typically deployed as a wireless local area network (WLAN) that may extend home and business networks to wireless medium. As referenced, the IEEE 802,11 standard defines WiFi communications as between devices, and as between devices and access points. WiFi typically provides aggregate user data speeds from 2 Mbps (for 802.11b) to approximately 150 Mbps (for802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

Target markets are athletics—football, archery, golf, skate boarding etc. etc. Secondary markets are body mechanics, industrial testing of various types. Overall purpose of the hardware is to capture and transmit real time data to a data base/smart phone using short distance wireless communication.

First Application will involve a small device that can be affixed to the nook of an arrow shaft. Device would measure rotation, wobble, weight etc. to provide performance improvement data to a user.

Second Application could be the bottom of a skate board to measure acceleration and distance or perhaps the shaft of a golf club to measure the many variables of a golfer's swing.

Third Application would be a football helmet (any helmet for that matter) to measure impact for safety reasons or individual/team performance data etc.

Application 1: Archery

Dimensions: Cylinder Shaped: Max Diameter 0.202 to 0.204″ Length: 1-1.5″

Power: Small replaceable battery or inductive charger

Measurement: 3 axis, high G rating (capable of cohabitating with devices that travel 0-500 ft/s or nearly instantly as in the case of an arrow) accelerometer.

Wireless: Bluetooth. Minimum 10 ft distance. Primary use is to transfer data to mobile application (assume on board storage of data while swing or arrow travel is taking place)

Housing: Custom housing for circuit to be inserted into and then “stuck” to the sports equipment device. Could use pouch instead of hard case.

I/O: Power switch (screw type preferably). LED (pulsed for battery life)

Market Entry: Ideally the end of this year, but will be driven by feasibility, component choice and application.

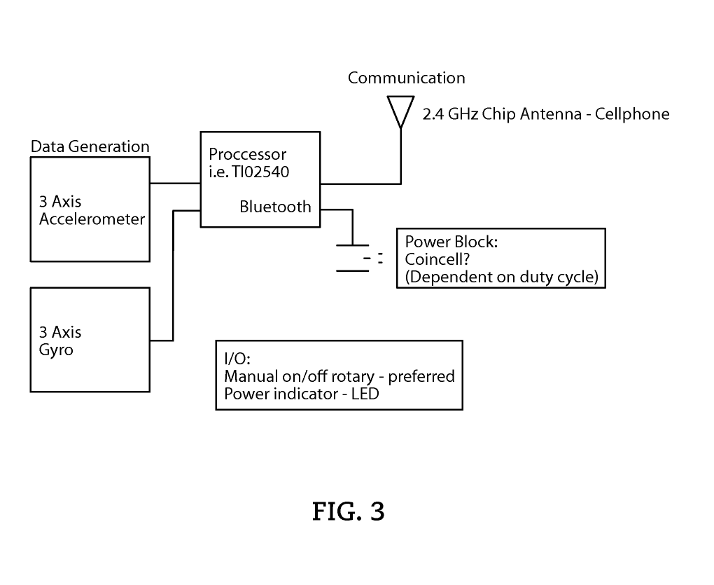

See FIG. 3 for a System Functional Block Diagram All sports related data acquisition and transmission applications.

Function Block Component Suppliers

Data Collection

| Company | Accelerometer | Gyro |
|---|---|---|
| ST Micro | ✓ | ✓ |
| K-Tronics (Eng. Co.) | ✓ | ✓ |
| Analog Devices | ✓ | ✓ |

Processor

| | | high | WiFi | | Low |
|---|---|---|---|---|---|
| Company | Part | speed | Radio | Storage | Energy |
| Texas Instruments | CC2540 | ✓ | ✓ | ✓ | ✓ |
| BLE (formerly Wibree) | BTY0 | ✓ | ✓ | ✓ | ✓ |

Communications

| Company | Antenna (chip) | 2.4 GHz |
|---|---|---|
| Panasonic | ✓ | ✓ |
| Murata | ✓ | ✓ |

Use Cases

Each sporting application's Use Case will determine essential design specifications such as packet size, transmission rates, component selection, system and sub-system duty cycles, power budgeting, and enclosure space requirements.

| | | | | Transmission |
|---|---|---|---|---|
| | | | | Frequency |
| Application | User(s) | How Many (Data Streams) | | (Data Rate) |
| Archery | single/ | 1 to 14 | Archer/Archery | Real Time/stored |
| | multiple | | Tournament/both? | data - periodic |
| | | | | data dump |
| Football | single/ | 11-40-100 | Team on Field/ | Real Time/stored |
| | multiple | | plus bench/both | data - periodic |
| | | | teams | data dump |

Data Generation

Measurement Factors:

1. Location—Typical compass and navigation equipment operate by means of a mechanical device that moves in relation to an object's (automobile, airplane, boat) relative position to the earth's magnetic field about the X, Y, or Z axis. Electronic based compass/navigation equipment provides this same functionality but with less maintenance, better reliability, and higher accuracy. These parts consist of integrated circuits that require mounting and associated components for proper operation. Solutions come in varying levels of integration and may include other features that aid in calibration, achieving higher accuracy and tilt compensation.

Existing solutions are typically 3 axis fixed location; variable location may be a design concern possibly requiring R&D or integration with other factor solutions.

Acceleration—An accelerometer is an electromechanical device used to measure changes in velocity over time. Practical applications include sensing orientation and vibration as well as shock and fall detection. Sensing acceleration is accomplished through a variety of technologies, many of which use microelectromechanical systems (MEMS).

Existing solutions may have a problem with a single axis vector as it could stop measurement at peak velocity; if arrow were traveling in a circle the sensor would be constantly on; likely to be a design concern.

Rotation—A non-contact rotation sensor utilizes multiple hall elements formed on a silicon substrate. Combined with a disc magnet polarized in the radial direction, the sensor IC provides a non-contact rotation angle sensor solution.

Solutions detect rotation in an absolute angle; angle variability likely to be a design concern.

Gravity—inclinometers are used for measuring angles of slope (or tilt), elevation, or inclination of an object with respect to gravity. These sensors are used in aircraft flight controls, cameras, automotive security systems, platform leveling, and other specialized applications.

Accelerometer solutions should incorporate this factor.

Atmospheric Pressure—Pressure sensors are devices that are designed to accurately detect the magnitude of external force applications (PSI).

Not sure this factor would significantly alter performance data over a limited time span (i.e. arrow flight or single down FTBL).

Data Transmission Considerations:

Bluetooth:

Single Athlete—250 Kbps—Standard Bluetooth

Multiple Athletes—1 Mbps—Enhanced data rate Bluetooth technology. identify signals (i.e. team play)—Filter signals by frequency or transmission sequence. High speed Bluetooth) operates at a range of 5 to 10 meters (about 16.5 to 33 feet) with a data rate of up to 1 megabit per second (Mbps) in the 2.4-GHz radio-frequency (RF) band. It can be deployed on a stand-alone chip or on a dual-mode chip along with conventional Bluetooth if both transmission rates are needed for the application.

Wireless Network Standards: WiFi allows the transmission of large amounts of data by single packet or continuously; however consumption can be high. WIFI: 802.11 a/b/g or b/g/n chips are widely available.

WiFi 802.11 wireless network standards

| | | | | Data rate | | | Approximate | | Approximate | |
|---|---|---|---|---|---|---|---|---|---|---|
| 802.11 | | Freq. | Bandwidth | per stream | Allowable | | indoor range | | outdoor range | |
| Protocols | Release | (GHz) | (MHz) | (Mbit/s) | MIMO | Modulation | (m) | (ft) | (m) | (ft) |
| — | June 1997 | 2.4 | 20 | 1, 2 | 1 | DSSS, | 20 | 66 | 100 | 330 |
| | | | | | | FHSS | | | | |
| a | September 1999 | 5 | 20 | 6, 9, 12, 18, 24, 36, | 1 | OFDM | 35 | 115 | 120 | 390 |
| | | 3.7 | | 48, 54 | | | — | — | 5,000 | 16,000 |
| b | September 1999 | 2.4 | 20 | 1, 2, 5.5, 11 | 1 | DSSS | 35 | 115 | 140 | 460 |
| g | June 2003 | 2.4 | 20 | 6, 9, 12, 18, 24, 36, | 1 | OFDM, | 38 | 125 | 140 | 460 |
| | | | | 48, 54 | | DSSS | | | | |
| n | October 2009 | 2.4/5 | 20 | 7.2, 14.4, 21.7, 28.9, | 4 | OFDM | 70 | 230 | 250 | 820 |
| | | | | 43.3, 57.8, 65, 72.2 | | | | | | |
| | | | 40 | 135, 150 | | | 70 | 230 | 250 | 820 |

System Design Considerations:

| Functionality | Design Considerations |
|---|---|
| 1. Data Acquisition - Real Time | Memory requirements? |
| Data or Sample Data (store & | Power utilization |
| forward) | |
| 2. Data Transmission - Real Time | Data transmission rate? |
| or Periodic | Packet size? |
| | Power utilization? |
| 3. Processing - | MIPS (to service data processing |
| | 1&2)? |
| | Peripheral interfaces? |
| 4. Power - | Sips or Drinks energy? |
| | Power management needed? |
| | Replaceable or rechargeable? |
| 5. Control (device activation) - | Momentary or toggle? |
| 6. Indicator (power) - | Momentary or constant on? |
| 7. Enclosure (housing) - | Size (per application and based on |
| | existing parts) |
| | Mechanical Layout (i.e bulky |
| | standard parts) |
| | Equipment Attachment |
| | (per application and based on sport' |
| | equipment) |
| | Durability |
| | (per application and based on stress) |

The system as described in the Iron Mountain PRD is feasible as a concept and also from a base functional point of view. That said, the physics involved with each application and the performance of a circuit to expectations is likely to be challenging. Though a functional block diagram is simple, a common circuit design that is applicable to all or several applications (let alone the components available to make it work as desired) can be complex and a design challenge as well.

It is essential that the required performance be translated into engineering terms so that a circuit can be designed. Knowing what data you want to acquire and how often you need to send it to a receiver is essential. A “Use Case” specification should be developed for each sporting application. Prototyping and baseline performance analysis cannot be accomplished until this activity is performed. This activity could include a questionnaire with appropriate fields of technical factors to be sent to athletes participating in those sports.

Next, the physical packaging of a circuit for a specific application is likely to be challenging. More so for some applications such as Archery and less so for others such as Football, Lacrosse, and Racing which all use helmets with ample space. Circuit integration (combining existing die) may be possible to reduce space requirements. However feasibility is unknown at this time (many hurtles besides the practical engineering can be involved such as obtaining a license for its' use for instance).

Further input from technology specialists to confirm this first pass study's information is recommended. Resource requirements and budgeting estimates need to be established to move the project into an implementation stage. A device cost estimate is $5+/− depending on the intended use (see reference info) and availability of suitable components manufactured in high volume.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented platform providing networked access to a plurality of types of digital content, including:
a non-transitory computer readable storage medium having encoded thereon computer executable instructions for accessing content at least partially indicative of real time sports-related data at least partially utilizing short distance wireless communication within a communications network; and
at least one memory device accessibly coupled to at least one tracking system associated with an athlete capable of tracking at least one movement of the athlete during game play and the communications network.
